(19) United States
(12) Patent Application Publication
(10) Pub. No.: US 2002/0119818 A1
(43) Pub. Date: Aug. 29, 2002

(54) Apparatus and method for playing a video slot gaming machine having a bonus game

(75) Inventors: Russell Savio, Henderson, NV (US); Mark Karen, Las Vegas, NV (US); Brad D. Schultz, Las Vegas, NV (US); Shawn Falstrom, Las Vegas, NV (US); Robert Foresta, Las Vegas, NV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Konami Gaming, Inc., Las Vegas, NV (US)

(21) Appl. No.: 10/082,540

(22) Filed: Mar. 1, 2002

Related U.S. Application Data
(63) Continuation of application No. 09/724,093, filed on Nov. 28, 2000.

(51) Int. Cl. A63F 13/00

(52) U.S. Cl. 463/20

(57) ABSTRACT

A video slot gaming machine and operation thereof. The video slot gaming machine includes a housing having a display device for displaying a plurality of game elements in a grid having a plurality of cells, a memory device for storing a pay-table, and a game controller coupled to the display device and the memory device for randomly selecting the game elements to be displayed in the display device from a set of possible game elements. The cells are organized as horizontal reels. The game controller determines an outcome based on the displayed game elements, a pay-table, and predetermined pay-lines and to activate a bonus game in response to detecting a triggering event. The triggering event is defined as the appearance of a plurality of character game elements which comprise an aggregate symbol in a payline. The outcome of the bonus game is determined as a function of the triggering event and first and second random factors.

### BACKGROUND OF THE INVENTION

1. Field of the Invention

The present invention relates generally to video slot gaming machines and more particularly, to an apparatus and method for playing the video slot gaming machine having a bonus game and a readable recording medium recording a control program for playing a video slot gaming machine having a bonus game.

2. Description of the Prior Art

Gaming machines, such as slot machines, are a cornerstone of the gaming industry. Generally, the popularity of such machines with players is dependent on the perceived likelihood of winning money at the particular game and the intrinsic entertainment value of the game relative to other available gaming options. In addition, some players avoid slot machine games because such traditional slot games include multi-line pay-outs based on complex pay-lines which are difficult but important to understand in order to make an informed wager. Where the available gaming options include a number of competing games and the expectation of winning each game is believed to be generally the same, players are most likely to be attracted to the most entertaining and exciting games in which the results are easy to understand such that cognizable wagers may be placed. Thus, in many instances, gaming operators strive to employ the most entertaining, exciting and simple multi-line games available because such games attract frequent play by less experienced players and, hence, increase profitability to the operator. Traditionally, a multi-line video slot gaming machine includes a plurality of game elements, vertical spinning reels, complex multiple pay-lines and a controller for randomly aligning the pluralities of game elements on a display upon initiation of the game by a player. Generally, where the randomly aligned pluralities of symbols result in a winning combination of game elements stored in a pay-out table, the player receives a pay-out based on the wager placed by the player. Furthermore, one concept that has been successfully employed to enhance the entertainment value of the game is the addition of a bonus game which may be played in conjunction with the “primary” game. The bonus game may comprise any type of game, either similar to or completely different from the base game. The bonus game is initiated upon the occurrence of a selected event or outcome of the primary game.

Such video slot gaming machine concepts are the subject of U.S. Pat. No. 6,231,442, issued May 15, 2001 in the name of Mayeroff and U.S. Pat. No. 6,234,897, issued May 22, 2001 in the name of Frohm, et al. The '442 and '897 patents disclose an embodiment wherein the base game is a slot machine game implemented on a video display. The '442 patent discloses a primary game and a bonus game comprising a selection game. Whenever the player achieves a combination of symbols on the main game, the player is awarded with the opportunity to play the secondary event selection game wherein the player is provided with multiple items having a mystery multiplier which is then applied to the wager bet by the player. The '897 patent discloses a primary game and a variable bonus pay-out game wherein the expected values of the bonus game are based on different arrangements of the start-bonus symbols resulting from the primary game.

Because the excitement and entertainment value of the primary game provides increased player appeal relative to other gaming machines and the bonus game concept increases player appeal and excitement, thereby increasing the chance to win and the potential pay-out amount, there is a continuing need to develop new features for primary and bonus games. New features are necessary to appeal to player interest and enhance excitement in order to entice longer play and satisfy demands of operators for interesting games and increased profitability. The present invention is directed to satisfying these needs.

### SUMMARY OF THE INVENTION AND ADVANTAGES

It is an object of the present invention to provide a slot machine providing more excitement, higher entertainment value and paylines that are easy to understand, thereby attracting increased numbers of patrons to play and enticing them to play longer.

The video slot gaming machine of the present invention provides a slot machine comprising a housing having an operation panel on a front side, a main display device, an input device capable of issuing information corresponding to an operation of a player, and a game controller for controlling a process of a game performed on a screen of the main display based on the information received from the input device.

The video slot gaming machine of the present invention includes a housing having a display device for displaying a plurality of game elements in a grid. The grid includes a plurality of cells, wherein the cells represent a plurality of horizontal reels. The machine further includes a memory device for storing a pay-table; and a game controller coupled to the display device and the memory device. The game controller randomly selects the game elements to be displayed in the display device and determines an outcome based on the displayed game elements, a pay-table, predetermined vertical pay-lines, and a wager made by a player playing the gaming machine.

In another embodiment, the video slot gaming machine includes a housing having a display device for displaying game elements in a grid having a plurality of cells. The machine further includes a memory device for storing a pay-table and, a game controller coupled to the display device and the memory device. The game controller randomly selects the game elements to be displayed in the display device from a set of possible game elements and determines an outcome based on the displayed game elements, a pay-table, and predetermined pay-lines, The game controller is further adapted to animate the display device to represent the sliding of horizontal reels and randomly select a game element for each cell. The set of possible game elements includes gems and symbols representing the legs, torso and arms, and head of first, second, and third characters, including characters having different shapes and colors.

In yet another embodiment of the present invention, the video slot gaming machine includes a housing having a display device for displaying game elements in a grid having a plurality of cells. The machine further includes a memory device for storing a pay-table and a game controller coupled to the display device and the memory device. The game controller randomly selects the game elements to be displayed in the display device from a set of possible game elements and determines an outcome based on the displayed game elements, a pay-table, and predetermined pay-lines, the set of possible game elements includes character game elements which comprise an aggregate symbol. The game controller is adapted to activate a bonus game in response to the plurality of character game elements being located along one of the paylines. The bonus game may be a sport such as gymnastics, diving or basketball. In yet another embodiment of the present invention, the game controller is adapted to activate a bonus game in response to detecting a triggering event and to determine an outcome of the bonus game, wherein the outcome of the bonus game is determined as a function of the triggering event and first and second random factors. The triggering event is a plurality of character game elements which comprise an aggregate symbol being located along one of the paylines.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view showing an embodiment of a slot machine to which the present invention is applied;

FIG. 2 is a block diagram illustrating a schematic configuration of a control system of the slot machine illustrated in FIG. 1;

FIG. 3 is a display of a first and second plurality of game elements in a first display during a normal random display having a winning combination appearing within the first display;

FIG. 4 is similar to FIG. 2 but showing a first symbol united and moving;

FIG. 5 is a display of a plurality of bonus games in the second display of FIG. 1;

FIG. 6 is a display of the first symbol performing one of the bonus games of FIG. 5; FIG. 7 is a display of the first symbol performing one of the bonus games of FIG. 5;

FIG. 8 is a display of the plurality of bonus outcomes of the video slot machine of FIG. 1 including a crowd meter and a plurality of ratings generated by a plurality of judges;

FIG. 9 is a display of a total bonus factor for determining a pay-out sum to be distributed to a player;

FIG. 10 is a flow diagram of a method for playing the video slot machine of FIG. 1, according to a first aspect of the present invention;

FIG. 11 is a flow diagram of a method for playing the video slot machine of FIG. 1, according to a first aspect of the present invention; and,

FIG. 12 is a flow diagram of a method for playing the video slot machine of FIG. 1, according to a first aspect of the present invention.

### DETAILED DESCRIPTION OF THE PREFERRED EMBODIMENT

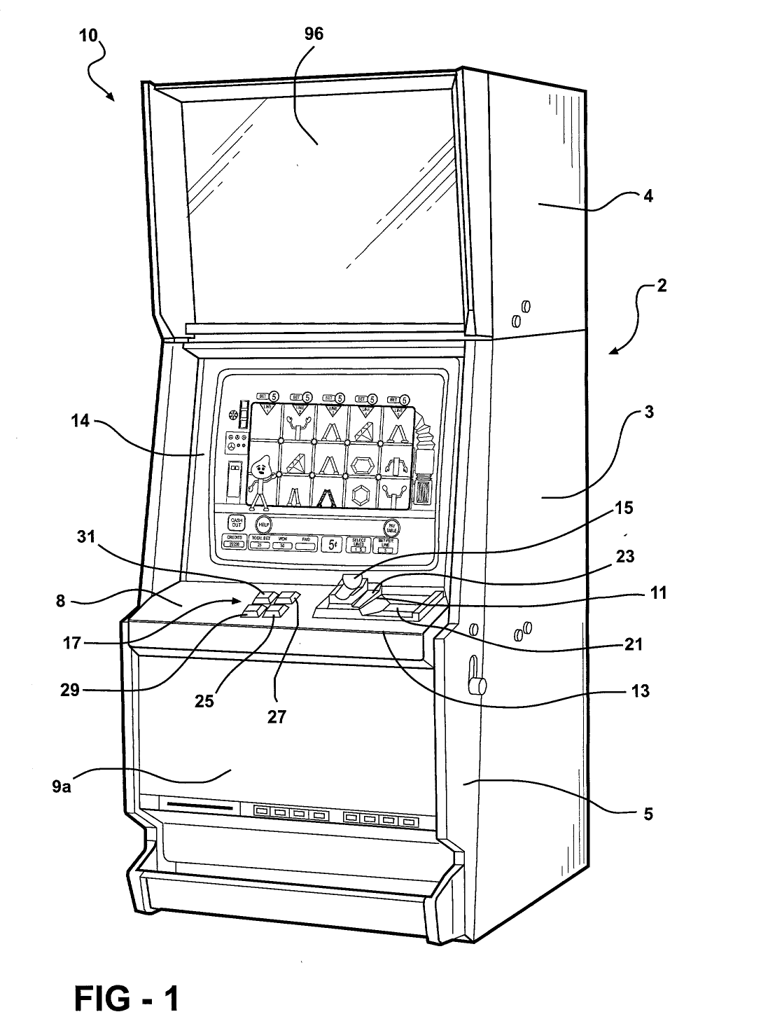

With reference to the drawings and in operation, the present invention provides a video slot gaming machine 10. With reference to FIG. 1, an exemplary video gaming machine 10 is illustrated into which the present invention can be incorporated to improve the enjoyment of a video game and to thereby increase the amount of time that the video game is played by patrons of a gaming establishment. FIG. 1 shows a general appearance of the video gaming machine 10 to which the present invention is applied. As shown in the FIG. 1, the machine 10 comprises a housing 2 standing upright. The housing 2 comprises a main body 3, a top box 4 mounted on a top portion of the main body 3 and a door 5 attached to a front side of the main body 3 so as to be swingable between an open position and a close position.

At a center portion of the front side of the main body 3, there is mounted a main display device 14 comprising a CRT, and below the display 14 is provided an operation panel 8. The operation panel 8 is attached to the door 5 so as to slope down in a forward direction of the machine 10. Below the operation panel 8 and on a front side of the top box 4, there are provided decoration panels 9a and 9b on which pictures, letters and the like representing a title of the machine 10 or the like are illustrated.

As shown in FIG. 1, the operation panel 8 is provided, from a right end toward a left end thereof, with an insertion portion 11, and an input portion 17. Note that the word coins includes coins or tokens.

In the exemplary input portion 17 shown, four push button switches 25, 27, 29, 31 are provided as first input devices, each of which is capable of being depressed. The push button switches 25, 27, 29, 31 are selected as switches to be operated with particular high frequency during the game, so that theses switches are provided on the operation panel 8. For example, the push button switch 29 at a lower left position of the four switches is operated for starting the game. The number of the push buttons provided at the input portion 17 and functions assigned to the push buttons can be properly changed.

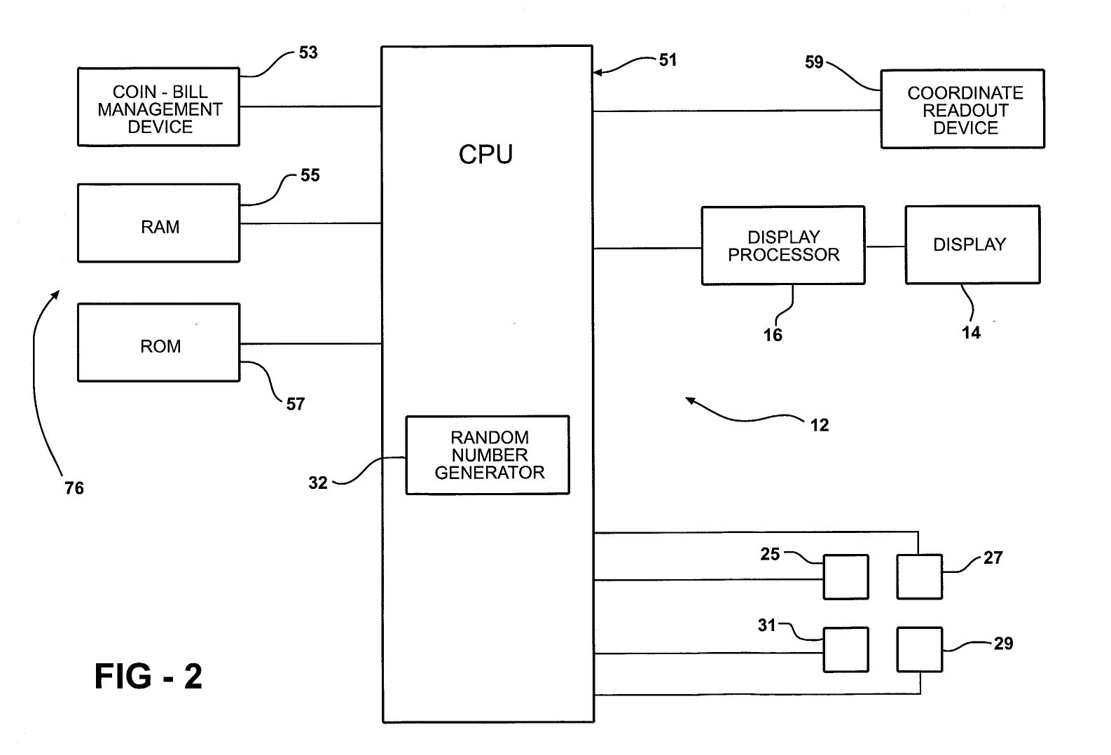

FIG. 2 is a block diagram illustrating a schematic configuration of a control system or game controller 12 provided in the machine 10. The game controller 12 includes a central processing unit (CPU) 51, a coin-bill management device 53, a display processor 16, a RAM 55 as a memory device and a ROM or EPROM 57. The CPU 51 is mainly composed of a microprocessor unit and performs various calculations and motion control necessary for the progress of the game.

The coin-bill management device 53 detects the insertion of a coin or token or bill from the coin insertion portion 15 and the bill insertion portion 21, and performs a necessary process for managing the coin or bill. For example, the device 53 judges whether the medal and the slip are real or counterfeit, and keeps the medal and the slip judged as real while rejecting the medal and the slip judged as counterfeit. The display processor 16 interpret commands issued from the CPU 51 and displays desirable images on the display 14. The RAM 55 temporarily stores programs and data necessary for the progress of the game, and the ROM 57 stores, in advance, programs and data, e.g., the paytables, for controlling basic operation of the machine 10, such as the booting operation thereof and the game code and graphics.

The video gaming machine 10 of FIG. 1 further includes the display 14, which, in one embodiment described herein, is advantageously a conventional VGA display monitor.

As will be discussed below, the VGA display displays a simulation of a slot game, or other game of chance, and a player using the video gaming machine 10 interacts with the simulated game.

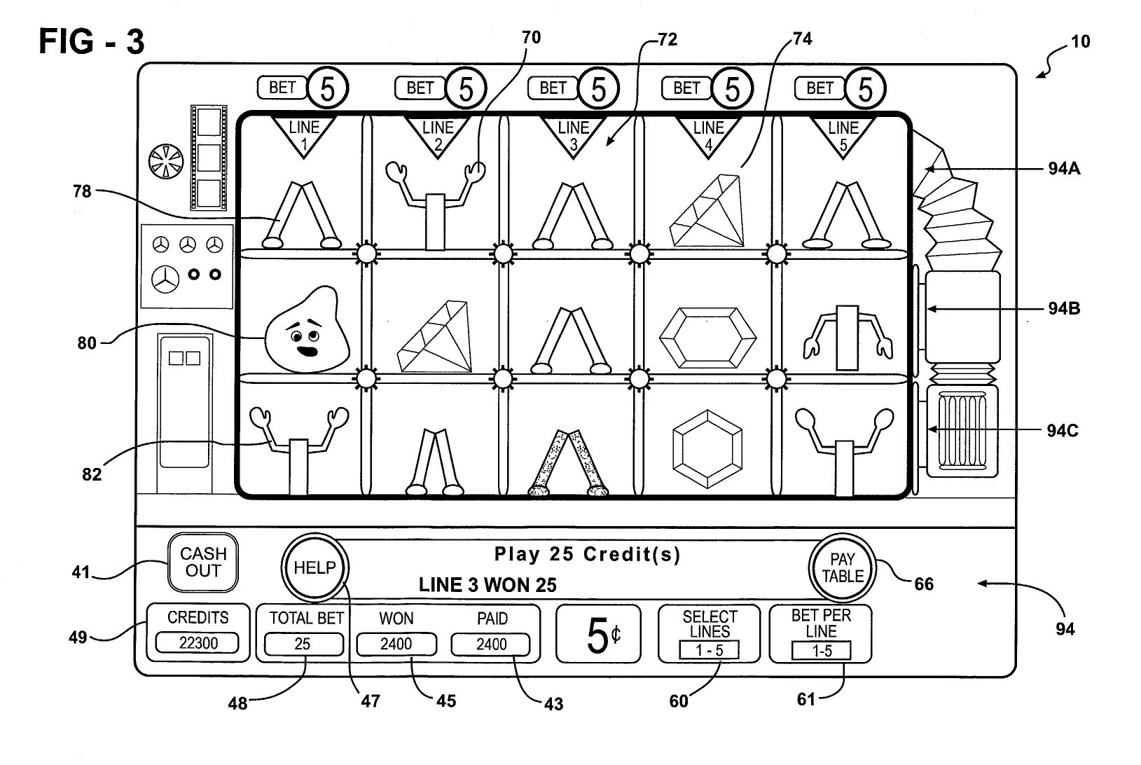

With reference to FIGS. 2 and 3, the CPU 51 is electrically connected with a coordinate readout device 59 as well as the above mentioned push button switches 25, 27, 29, 31. The coordinate readout device 59 works as a second input device and comprises, for example, a so-called touch panel 44 formed as a transparent panel and is capable of issuing signals corresponding to the coordinates of a position touched by the player. The coordinate readout device 59 is closely put on the surface of the display 14.

With reference to FIG. 3, the touch panel 44 provides a plurality of touch surfaces or buttons on the display device 14, which when touched by the player serves as input devices to the game controller 51. In the illustrated embodiment, the touch panel 44 provides a cash out button 41, a help button 47, a pay table button 66, a select lines button 60 and a bet per line button 61. Actuation or touching of the cash out button 41 distributes any accumulated credits to the player. Actuation of the help button 47 displays instructions for the game.

Actuation of the pay table button 66 displays the pay table for the game. Actuation of the select lines button 60 allows the player to toggle through the available sets of paylines. Preferably, the video slot gaming machine 10 is a multi-line game. The select lines button 60 allows the player to select the lines on which the player desires to bet.

The bet per line button 61 allows the player to toggle to increase the bet per line a credit at a time (up to the maximum bet).

The display 14 also includes a number of meters which display information to the player. A paid meter 43 keeps track of the total amount of winnings paid out to the player per play. A won meter 45 is displayed for informing the player of the number of winning credits accumulated per play. A total bet meter 48 displays the player's current bet (number of paylines selected x bet per line). A credit meter 49 indicates the player's available number of credits.

A random number generator 32 generates random numbers used for randomly selecting elements during game play, as described below.

With reference to FIGS. 1 and 2, the game controller 51 sends a signal to a display processor 16 for displaying a plurality of game elements 70 on the display 14.

Returning to FIG. 2, the game controller 12 is adapted to awarding a regular payout in response to the game elements 70 displayed on the display 14 matching a winning combination along one of the paylines selected by the player.

The game controller 12 also activates a bonus game a described below. The regular payout may vary for the amount of credits wagered according to a regular payout table (not shown).

Referring to FIGS. 1 through 3, the display device 14 displays a plurality of game elements 70 in a grid 72 having a plurality of cells 74. The cells 74 represent a plurality of horizontal reels 94A, 94B, 94C. A memory device 76 (comprising the RAM 55 and the ROM 57) stores a pay-table. The game controller 12 is coupled to the display device 14 and the memory device 76 and is adapted to randomly select the game elements 70 to be displayed in the display device 14. The game controller 12 is also adapted to determine an outcome based on the displayed game elements, a pay-table, and predetermined vertical pay-lines.

In one embodiment of the video slot gaming machine 10 of the present invention, the game controller 12 animates the display device 14 so as to depict horizontal sliding reels 94A,94B,94C, preferably, with the look and feel of a conveyer belt.

Moreover, in one embodiment, the game controller 12 is adapted to randomly select a game element 70 for each cell 74 while still appearing to the player to be sliding into position in the cells 74.

In another embodiment, the memory device 76 is adapted to store a plurality of arrays of game elements 18. Each array corresponds to a horizontal reel 94A, 94B, 94C. The game controller 12 is further adapted to select a stopping position for each array on the corresponding horizontal reel 94A,94B,94C. More specifically, the plurality of game elements 70 are disposed in a predetermined order in the array and the array appears to enter the display 12 from one side and slide into position in the grid 72 while providing a braking sound when coming to a stop in the cells 74.

In one embodiment, the set of possible game elements includes gems and symbols representing the legs, torso and arms, and head of first, second, and third characters. Preferably, the first, second, and third characters have different shapes and colors.

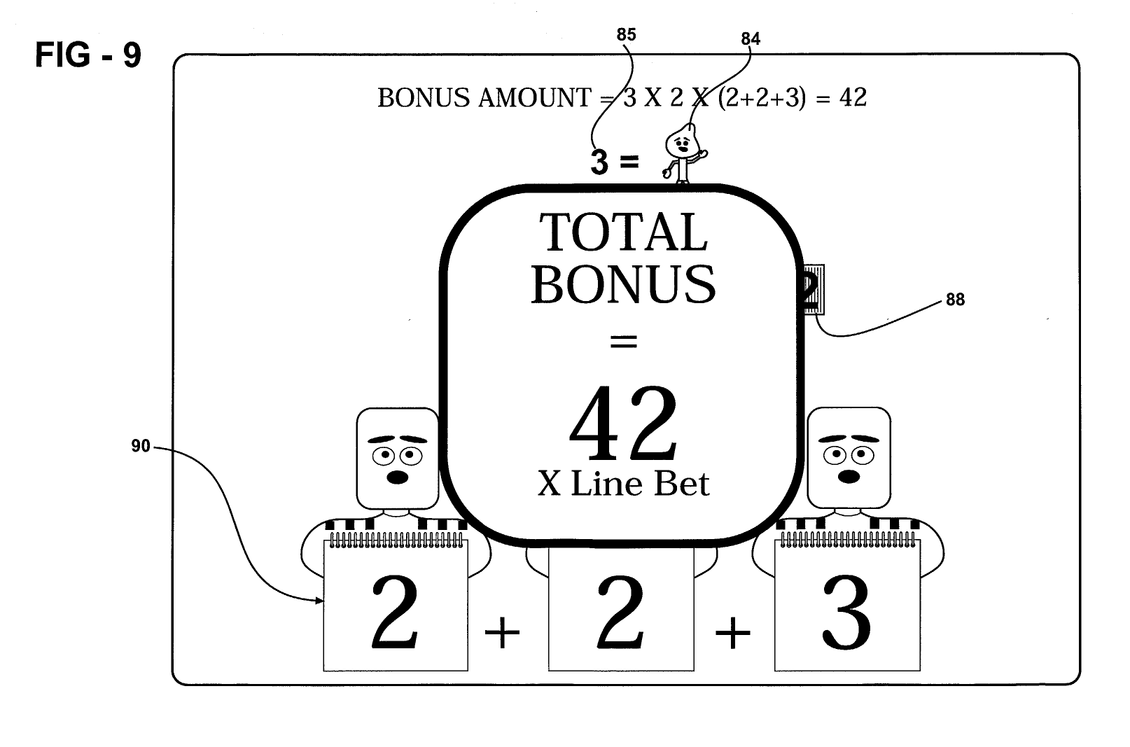

With reference to FIGS. 3 and 10, the operation of a video gaming machine 10 in accordance with a first embodiment of the present invention will now be described. In a first block 100, a plurality of game elements 70 are displayed in a grid 72 having a plurality of cells 74. The cells 74 represent horizontal reels. In a second block 102, a pay-table is stored in a memory device 76. In a third block 104, the game elements 70 to be displayed in the display device 14 are randomly selected. In a fourth block 105, an outcome based on the displayed game elements, a pay-table, predetermined vertical pay-lines, and a wager made by the player is determined. Each column of the grid 72 defines a vertical payline.

With reference to FIGS. 3-9, in another aspect of the present invention, the video gaming machine 10 implements a bonus game 86 in response to a triggering event.

The set of possible game elements 18 includes a plurality of character game elements which comprise an aggregate symbol or character 84. In the preferred embodiment, the aggregate symbol 84 is one of the first, second, and third characters, which are composed of the head, arms and torso, and leg symbols 78, 80, 82. The triggering event is defined as the presence of the character game elements 78, 80, 82 in a payline. For example, as shown in FIG. 3, the character game elements 78, 80, 82 are all located in the leftmost payline Line 1.

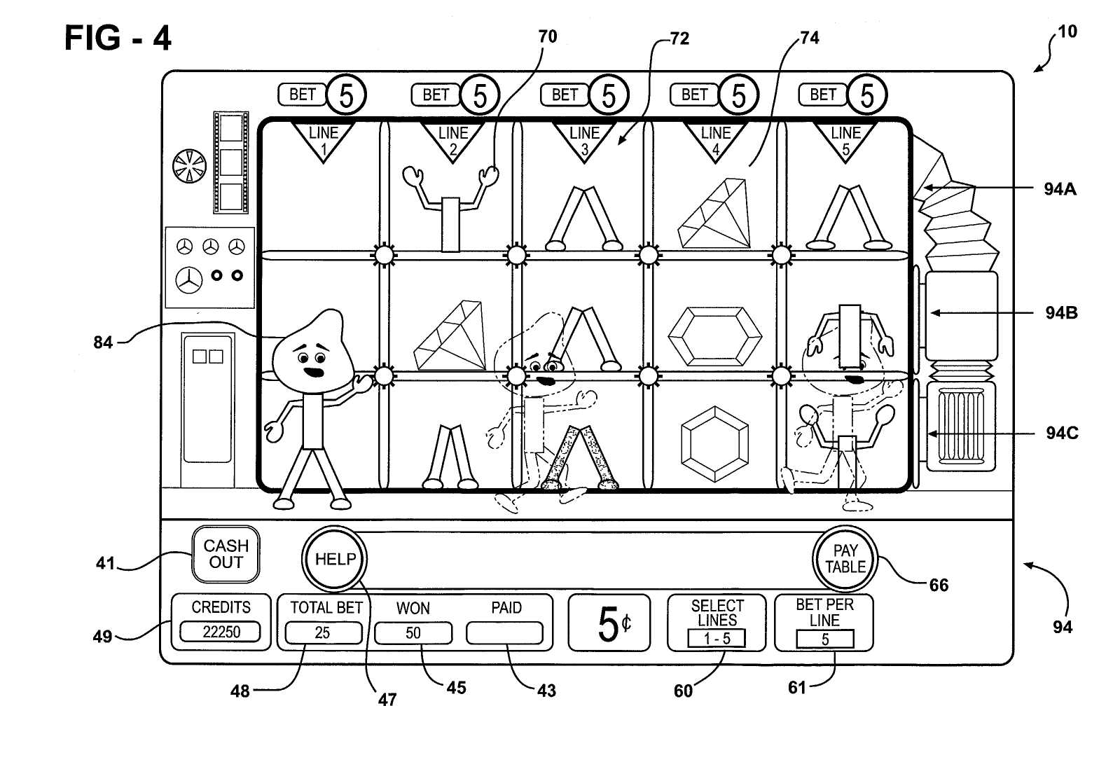

In the preferred embodiment, after the game controller 12 identifies the triggering event (and stops the reels 94A, 94B, 94C), the game controller 12 displays an animation of the aggregate symbol or character 84 uniting from the character game elements 78, 80, 82 and traversing across the display 14 (as shown in the dotted lines on FIG. 4) in a character dance.

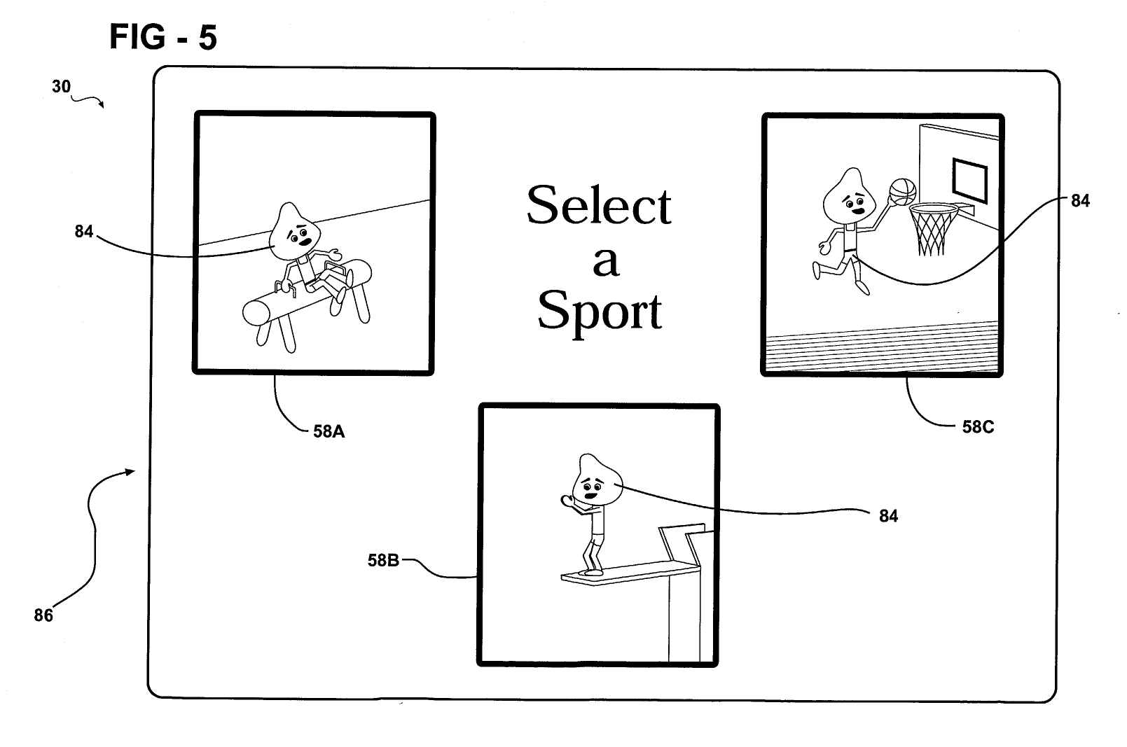

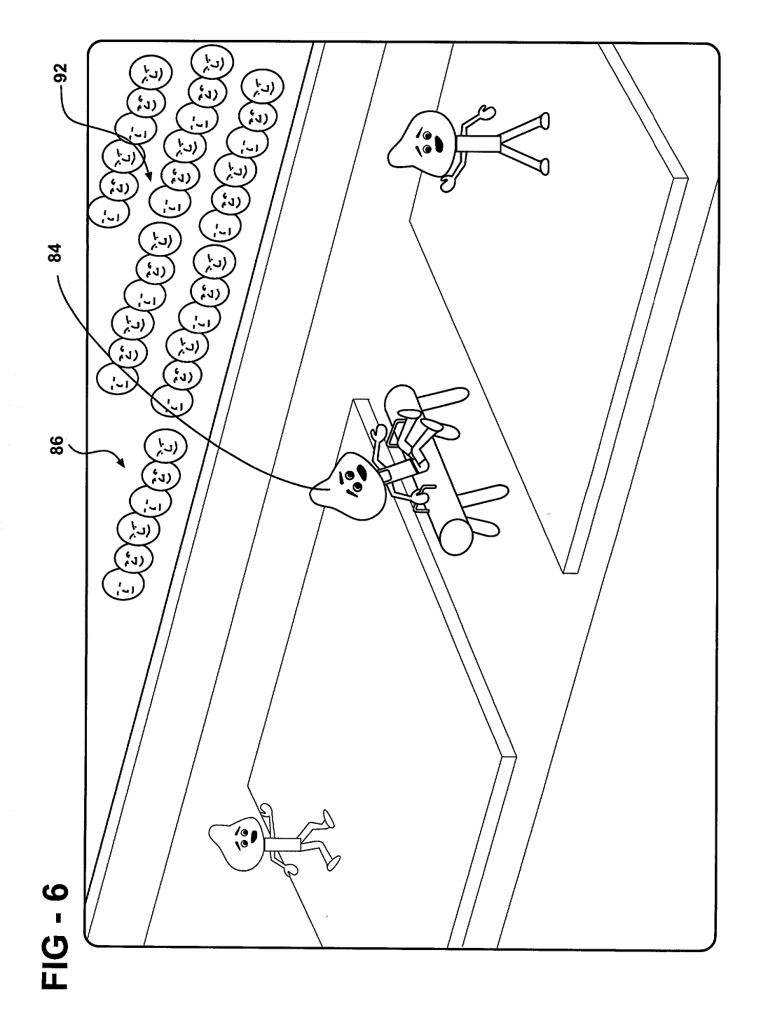

In one embodiment, the bonus game 86 is depicted as a sporting event. In the preferred embodiment, the player is given the option of choosing a sport, such as gymnastics, diving or basketball. With reference to FIG. 5, upon activation of the bonus game, the player is given an option of choosing gymnastics, diving, or basketball through a touch screen gymnastics button 58A, a touch screen diving button 58B, and a touch screen basketball button 58C. A representative gymnastics and diving event are illustrated in FIGS. 6 and 7, respectively.

Preferably, the outcome of the bonus game is determined as a function of the triggering event and first and second random factors. The game controller 12 is adapted to determine the outcome of the bonus game 86 and to display an animation of the selected event. The animation is representative of the outcome.

As discussed above, the triggering event is the appearance of the character game elements 78, 80, 82 of the first, second or third characters 84 appearing in a pay line. Each of the first, second and third characters 84 is assigned a value, e.g., 1, 2, or 3, which is used to determine the outcome of the bonus game 38 (see below).

In one embodiment, the first random factor is a random number from 1 to 10. Preferably, the first random factor is represented by the reaction, i.e., applause, of a crowd 92 (see FIGS. 6 and 7). Preferably, during the animation of the selected event, the crowd's 92 reaction is illustrated.

In one embodiment, the second random factor is a random number from 1 to 10. Preferably, the second random factor is represented as the scores of three judges 90.

In the preferred embodiment, after the bonus game is triggered, the game controller 12 randomly selects a general outcome of the event: good, fair, or bad. For each general outcome, each judge's 90 score is a random number between a given range. For example, for a general outcome of good, each judge's 90 score is a random number between 7-10; for a general outcome of fair, each judge's 90 score is a random number between 4-6; and for a general outcome of bad, each judges 90 score is a random number between 1-3. Alternatively, these outcomes may be weighted to traditional desired mathematical probabilities.

Additionally, the animation of the event is preferably, representative of the general outcome. However, the first factor, i.e., applause, is independent of the general outcome.

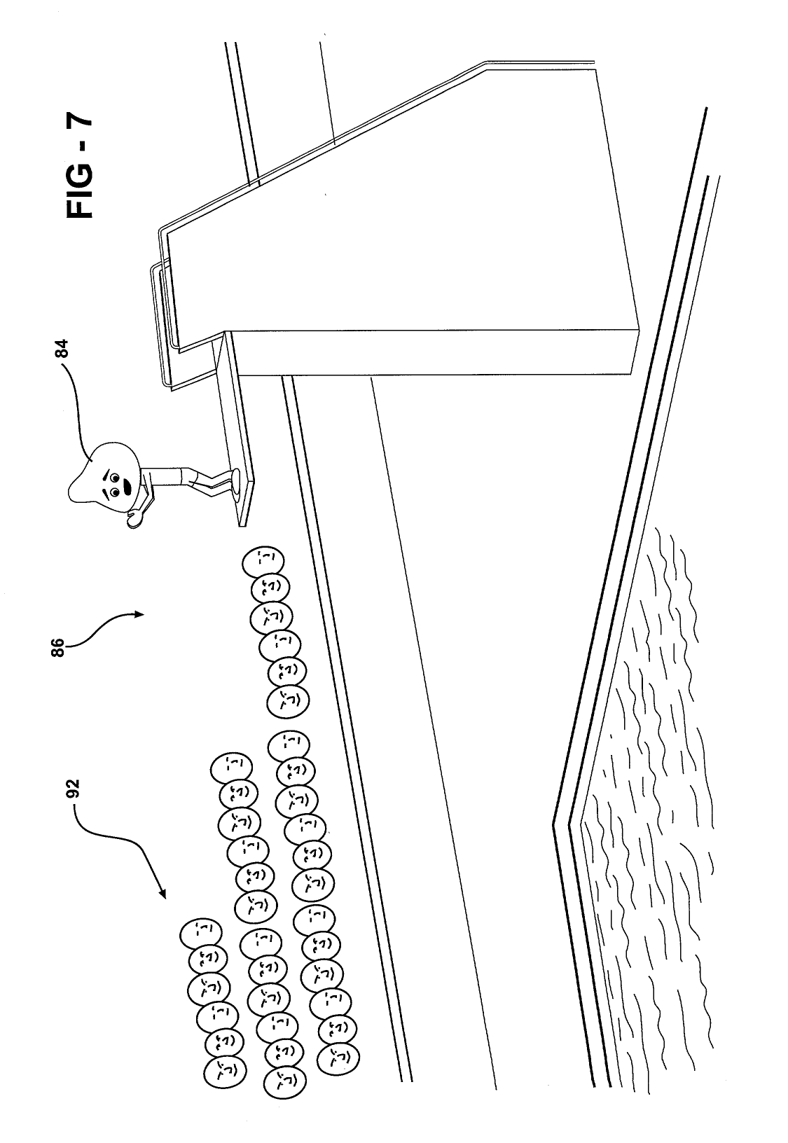

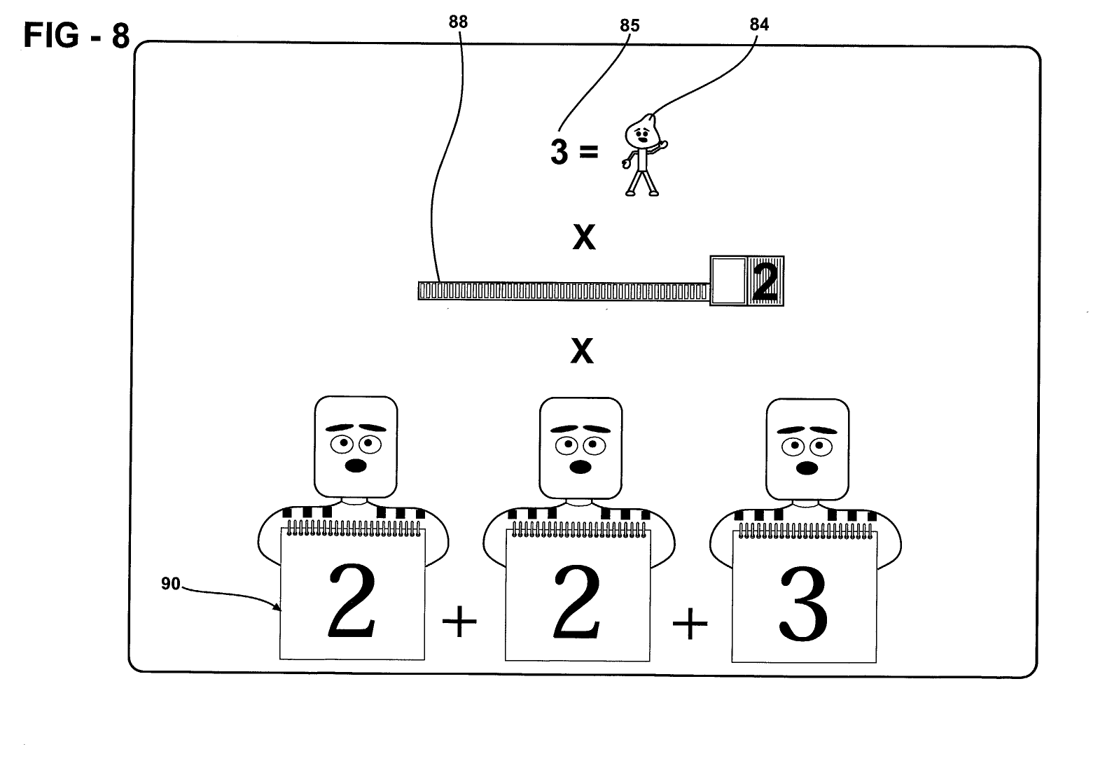

With reference to FIGS. 8 and 9, the outcome of the bonus game 86 is the value associated with the first, second and third characters (1, 2 or 3) multiplied by the first and second random factors multiplied by the players wager (line bet). For example, as shown, the character has a value of 3, which is multiplied by the applause factor of 2, which is multiplied by the sum of the judges scores, i.e., 3×2×(2+2+3)=42.

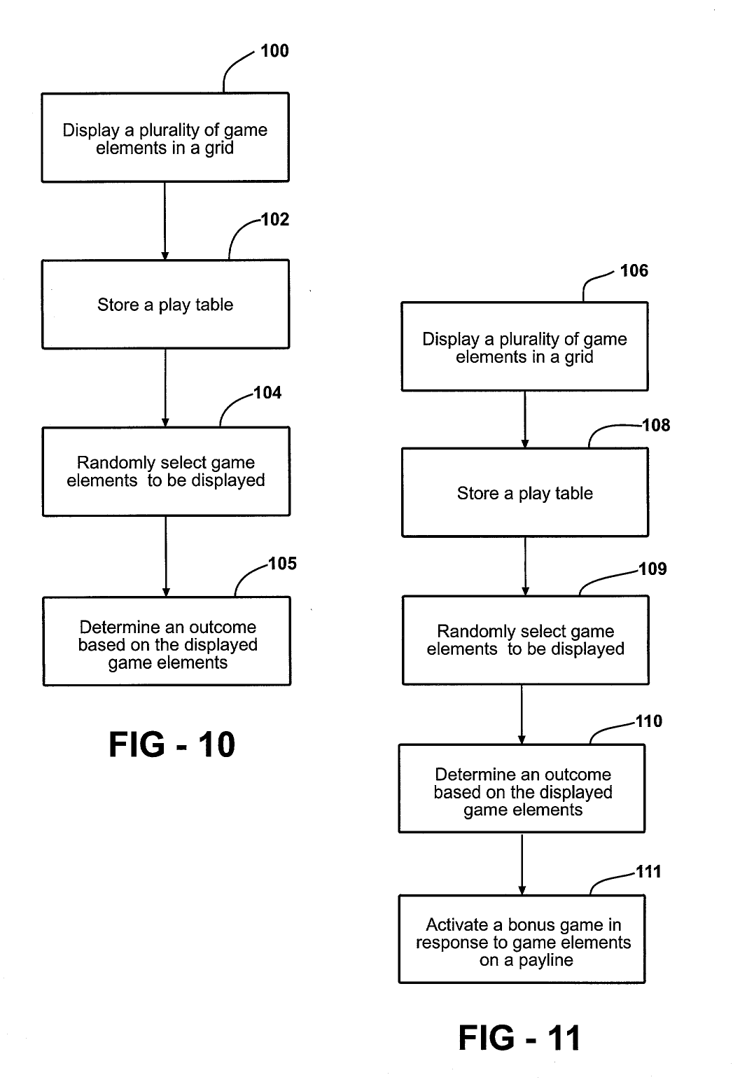

With reference to FIG. 11, the operation of a video gaming machine 10 in accordance with a second aspect of the present invention will now be described. In a first block 106, a plurality of game elements 70 are displayed in a grid 72 having a plurality of cells 76. In a second block 108, a pay-table is stored in the memory device 76. In a third block 109, the game elements 70 to be displayed in the display device 14 are randomly selected from a set of possible game elements. In a fourth block 110, an outcome is determined based on the displayed game elements, a pay-table, predetermined pay-lines, and a wager made by the player. The set of possible game elements 70 includes a plurality of character game elements which comprise an aggregate symbol. In a fifth block 111 a bonus game is activated in response to the plurality of character game elements being located along one of the paylines.

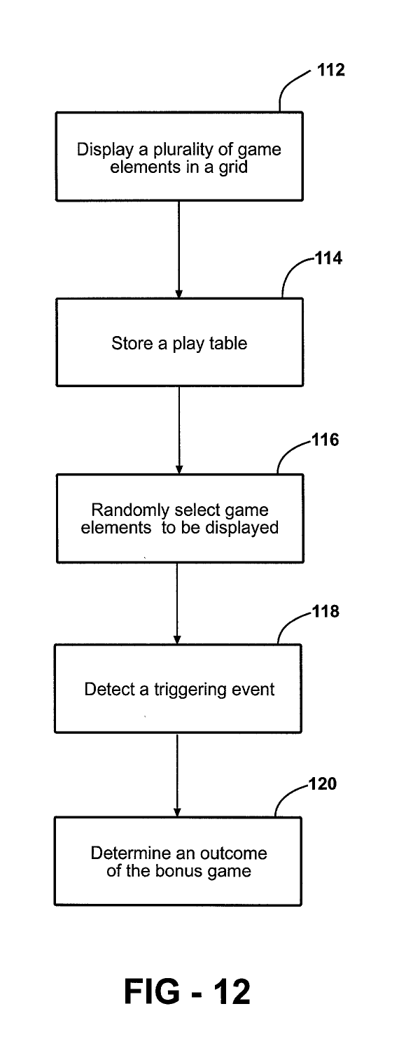

With reference to FIG. 12, the operation of a video gaming machine 10 in accordance with a third aspect of the present invention will now be described. In first block 112, a plurality of game elements are displayed in a grid 72 having a plurality of cells 74. In a second block 114, a pay-table is stored in a memory device 76. In a third block 116, the game elements to be displayed in the display device 14 are randomly selected from a set of possible game elements and an outcome is determined based on the displayed game elements, a pay-table, predetermined pay-lines, and a wager made by the player. In a fourth block 118, a triggering event is detected. In a fifth block 120, an outcome of the bonus game is determined. The outcome of the bonus game is determined as a function of the triggering event and first and second random factors.

It should be noted that although the present invention has been described above as being embodied in a stand-alone video slot game, the present invention may also be embodied in a piece of software for play on a stand-alone computer such as a personal computer. The present invention may also be provided in play over a computer network such as the internet.

Other aspects, objects and advantages of this invention can be obtained from a study of the drawings, the disclosure and the appended claims.

What is claimed is:

1. A video slot gaming machine for play by a player, comprising:
a housing having a display device for displaying a plurality of game elements in a grid having a plurality of cells, wherein the cells represent a plurality of horizontal reels;
a memory device for storing a pay-table; and,
a game controller coupled to the display device and the memory device for randomly selecting the game elements to be displayed in the display device and for determining an outcome based on the displayed game elements, a pay-table, predetermined vertical pay-lines, and a wager made by the player.

2. A video slot machine, as set forth in claim 1, wherein the game controller is adapted to animate the display device to represent the spinning of horizontal reels.

3. A video slot machine, as set forth in claim 1, wherein the game controller is adapted to randomly select a game element for each cell.

4. A video slot machine, as set forth in claim 1, wherein the memory device is adapted to store a plurality of arrays of game elements, each array corresponding to a horizontal reel.

5. A video slot machine, as set forth in claim 4, wherein the game controller is adapted to select a stopping position for each array on the corresponding horizontal reel.

6. A video slot machine, as set forth in claim 1, wherein the set of possible game elements includes gems and symbols representing the legs, torso and arms, and head of first, second, and third characters.

7. A video slot machine, as set forth in claim 6, wherein the first, second, and third characters have different shapes.

8. A video slot machine, as set forth in claim 6, wherein the first, second, and third characters have different colors.

9. A video slot gaming machine, comprising:
a housing having a display device for displaying a plurality of game elements in a grid having a plurality of cells;
a memory device for storing a pay-table; and,
a game controller coupled to the display device and the memory device for randomly selecting the game elements to be displayed in the display device from a set of possible game elements and determining an outcome based on the displayed game elements, a pay-table, and predetermined pay-lines, wherein the set of possible game elements includes a plurality of character game elements which comprise an aggregate symbol, and wherein the game controller is adapted to activate a bonus game in response to the plurality of character game elements being located along one of the paylines.

10. A video slot machine, as set forth in claim 9, wherein the bonus game is a sport.

11. A video slot machine, as set forth in claim 10, wherein the bonus game is a gymnastics game.

12. A video slot machine, as set forth in claim 10, wherein the bonus game is a diving game.

13. A video slot machine, as set forth in claim 10, wherein the bonus game is a basketball game.

14. A video slot machine, as set forth in claim 9, wherein the plurality of cells represent horizontal reels.

15. A video slot machine comprising:
a housing having a display device for displaying a plurality of game elements in a grid having a plurality of cells;
a memory device for storing a pay-table; and,
a game controller coupled to the display device and the memory device for randomly selecting the game elements to be displayed in the display device from a set of possible game elements and determining an outcome based on the displayed game elements, a pay-table, and predetermined pay-lines, wherein the game controller is adapted to activate a bonus game in response to detecting a triggering event and to determine an outcome of the bonus game, wherein the outcome of the bonus game is determined as a function of the triggering event and first and second random factors.

16. A video slot machine, as set forth in claim 15, wherein the triggering event is a plurality of character game elements which comprise an aggregate symbol being located along one of the paylines.

17. A video slot machine, as set forth in claim 16, wherein the first random factor is an applause meter having a range from 1 to 10.

18. A video slot machine, as set forth in claim 17, wherein the game controller is adapted to animate a viewer in response to the first random factor.

19. A video slot machine, as set forth in claim 15, wherein the second random factor is a random number representing a plurality of judge scores.

20. A video slot machine, as set forth in claim 15, wherein the plurality of cells represent horizontal reels.

21. A method for playing a video slot game by a player, comprising:
displaying a plurality of game elements in a grid having a plurality of cells, wherein the cells represent horizontal reels;
storing a pay-table;
randomly selecting the game elements to be displayed in the display device;
determining an outcome based on the displayed game elements, a pay-table, predetermined vertical pay-lines, and a wager made by the player.

22. A method, as set forth in claim 21, including the step of animating the display device to represent the sliding of horizontal reels.

23. A method, as set forth in claim 21, including the step of randomly selecting a game element for each cell.

24. A method, as set forth in claim 21, including the step of storing a plurality of arrays of game elements, each array corresponding to a horizontal reel.

25. A method, as set forth in claim 24, including the step of selecting a stopping position for each array on the corresponding horizontal reel.

26. A method for playing a video slot game by a player, comprising:
displaying a plurality of game elements in a grid having a plurality of cells;
storing a pay-table;
randomly selecting the game elements to be displayed in the display device from a set of possible game elements; and,
determining an outcome based on the displayed game elements, a pay-table, predetermined pay-lines, and a wager made by the player, wherein the set of possible game elements includes a plurality of character game elements which comprise an aggregate symbol; and,
activating a bonus game in response to the plurality of character game elements being located along one of the paylines.

27. A method, as set forth in claim 26, wherein the bonus game is a sport.

28. A method, as set forth in claim 27, wherein the bonus game is a gymnastics game.

29. A method, as set forth in claim 27, wherein the bonus game is a diving game.

30. A method, as set forth in claim 27, wherein the bonus game is a basketball game.

31. A method, as set forth in claim 26, wherein the plurality of cells represent horizontal reels.

32. A method for playing a video slot game by a player, comprising:
displaying a plurality of game elements in a grid having a plurality of cells;
storing a pay-table; and,
randomly selecting the game elements to be displayed in the display device from a set of possible game elements and determining an outcome based on the displayed game elements, a pay-table, predetermined pay-lines, and a wager made by the player;
detecting a triggering event; and,
determining a n outcome of the bonus game, wherein the outcome of the bonus game is determined as a function of the triggering event and first and second random factors.

33. A method, as set forth in claim 32, wherein the triggering event is a plurality of character game elements which comprise an aggregate symbol being located along one of the paylines.

34. A method, as set forth in claim 32, wherein the first random factor is an applause meter having a range from 1 to 10.

35. A method, as set forth in claim 34, including the step of animating a viewer in response to the first random factor.

36. A method, as set forth in claim 33, wherein the second random factor is a random number representing a plurality of judge scores.

37. A method, as set forth in claim 32, wherein the plurality of cells represent horizontal reels.

38. A computer program product for playing a video game, the computer program product comprising a computer usable storage medium having computer readable program code means embodied in the medium, the computer readable program code means comprising:
computer readable program code means for displaying a plurality of game elements in a grid having a plurality of cells, wherein the cells represent horizontal reels;
computer readable program code means for storing a pay-table;
computer readable program code means for randomly selecting the game elements to be displayed in the display device; and,
computer readable program code means for determining an outcome based on the displayed game elements, a pay-table, predetermined vertical pay-lines, and a wager made by the player.

39. A computer program product for playing a video game, the computer program product comprising a computer usable storage medium having computer readable program code means embodied in the medium, the computer readable program code means comprising:
computer readable program code means for displaying a plurality of game elements in a grid having a plurality of cells;
computer readable program code means for storing a pay-table;
computer readable program code means for randomly selecting the game elements to be displayed in the display device from a set of possible game elements; and,
computer readable program code means for determining an outcome based on the displayed game elements, a pay-table, predetermined pay-lines, and a wager made by the player, wherein the set of possible game elements includes a plurality of character game elements which comprise an aggregate symbol; and,
computer readable program code means for activating a bonus game in response to the plurality of character game elements being located along one of the paylines.

40. A computer program product for playing a video game, the computer program product comprising a computer usable storage medium having computer readable program code means embodied in the medium, the computer readable program code means comprising:
computer readable program code means for displaying a plurality of game elements in a grid having a plurality of cells;
computer readable program code means for storing a pay-table;
computer readable program code means for randomly selecting the game elements to be displayed in the display device from a set of possible game elements and determining an outcome based on the displayed game elements, a pay-table, predetermined pay-lines, and a wager made by the player;
computer readable program code means for detecting a triggering event; and,
computer readable program code means for determining an outcome of the bonus game, wherein the outcome of the bonus game is determined as a function of the triggering event and first and second random factors.
